(19) United States
(12) Patent Application Publication
(10) Pub. No.: US 2005/0014124 A1
(43) Pub. Date: Jan. 20, 2005

(54) Teaching device and method utilizing puppets

(76) Inventor: Suzan A. Haeni, Huntington, NY (US)

Correspondence Address: Daniel D. Chapman;JACKSON WALKER L.L.P., Suite 2100, 112 E. Pecan Street, San Antonio, TX, 78205, US

(21) Appl. No.: 10/856,147

(22) Filed: May 28, 2004

Related U.S. Application Data
(60) Provisional application No. 60/475,187, filed on Jun. 2, 2003.

(51) Int. Cl. G09B 25/00

(52) U.S. Cl. 434/393

(57) ABSTRACT

A puppet having two sides, the two sides reflecting the same character. However, on the first side the character is bearing a face displaying a first emotion such as a smile reflecting happiness, and a second side with the same face except displaying a second emotion such as a frown reflecting sadness. The puppets are used, typically with a script bearing a portion for each side of the puppet, for instructing small children.

This application claims priority from and incorporates by reference U.S. provisional patent application Ser. No. 60/475,187 filed Jun. 2, 2003.

### FIELD OF THE INVENTION

A two-sided “emotional” interactive hand puppet for use with teaching.

### BACKGROUND

Teaching, especially teaching children is often assisted and enhanced for the use of a play toy. Most children are interested in and entertained by puppets. Applicant has found that the use of puppets, including the unique puppets set forth herein is a valuable and effective teaching device, which also has applications in child therapy.

### OBJECTS OF THE INVENTION

To provide a unique puppet and sets of puppets that display, on opposite sides thereof, two faces of a single character, which two faces reflect contrasting motions.

Another object of the present invention is to provide for a novel, interactive two sided puppet and method of use of the interactive puppet as part of the teaching lesson.

Another object of the present invention is to provide for a novel two sided puppet and method for teaching the same, the method of teaching including providing a story line to go with each of the two sides and the contrasting emotions thereof which story line turns in a bad or sad situation (sad face) into a good situation (happy face).

### SUMMARY OF THE INVENTION

A teaching and/or therapy device adapted for fitting the hand of a teacher or therapist, the device comprising a puppet having a first side with a first face depicting a first emotion, and a second side, generally opposite the first side, depicting the same face generally except with an expression reflecting a second, contrasting emotion.

Applicant's novel puppet may be used with a story line, the story line reflecting a bad/sad situation, which story line is provided to the children while generally simultaneously displaying a first (sad/bad) side of the puppet and a second story line while generally simultaneously displaying explaining a second/happy emotion on the face of the puppet.

### BRIEF DESCRIPTION OF THE DRAWINGS

FIG. 1A and 1B are two sides of a first embodiment (10A) of a hand puppet which embodiment discloses a female figure including face. The expression on the face in FIG. 1A contrasts with the reverse or opposite side of the hand puppet as illustrated in 1B.

FIG. 2A and 2B illustrate a second alternate preferred embodiment (10B) of Applicant's novel puppets. In this embodiment the two opposite sides appear generally the same except for the expression of the face, which carries contrasting emotions. In this embodiment a highly stylized costume, here displaying an oriental origin is provided.

FIG. 3A and 3B are provided to illustrate the third embodiment of Applicant's two sided puppets. Here embodiment (10C) illustrating a “humanized” animal with the two sides being substantially similar except for the contrasting expressions on the face.

### DESCRIPTION OF THE PREFERRED EMBODIMENTS

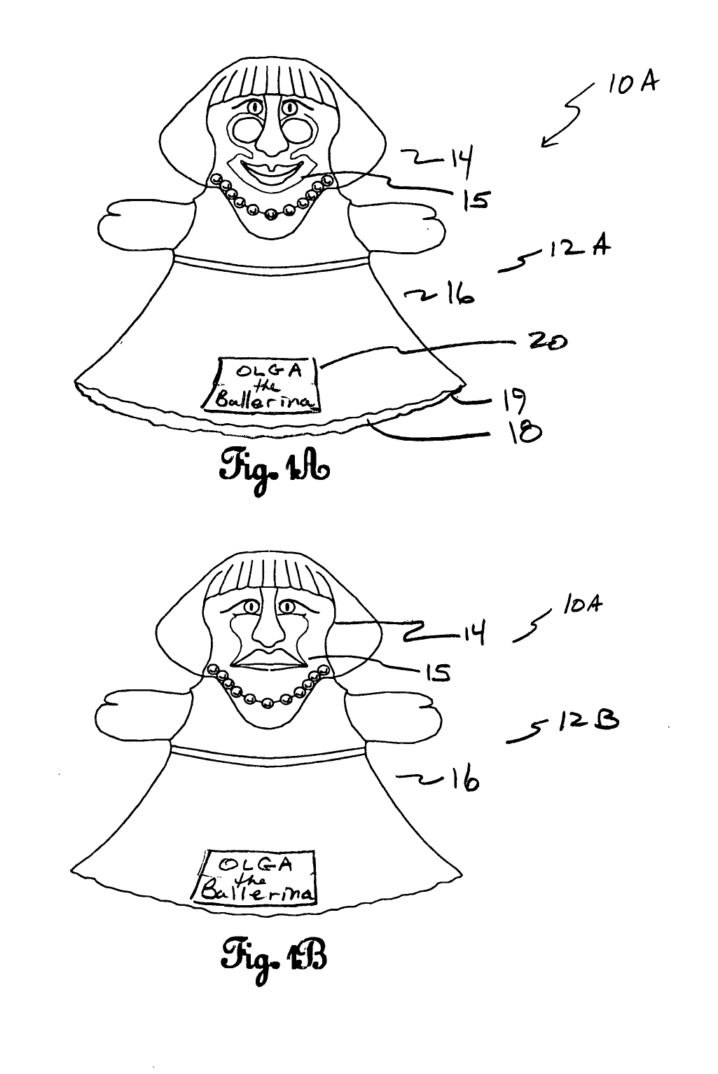

FIG. 1A and 1B, 2A and 2B and 3A and 3B illustrate three of Applicant's novel puppets (10A, 10B and 10C), each adapted to fit the hand of the teacher, instructor or therapist. Each puppet depicts, on two sides, a first side (12A) and a second side (12B) thereof, the same character with the same features, except that the first side reflects a first emotion, for example a sad face, and the second side depicts the same face reflecting a face depicting a second emotion, such as a glad/happy emotion depicted by a smile.

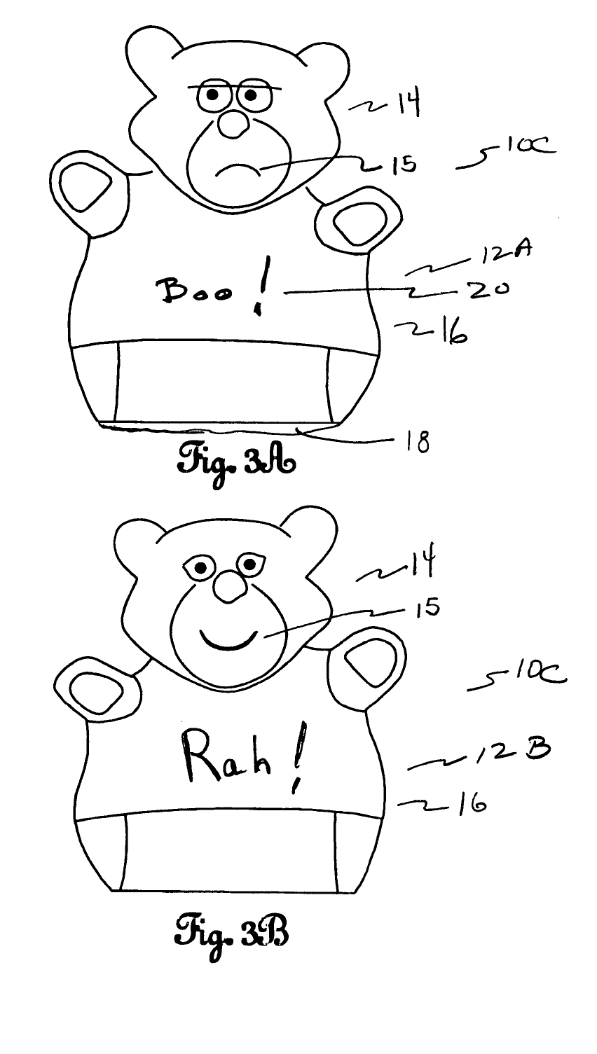

The characters which may be depicted include original and non-original cartoon characters, and stylized depictions of “humanized” animals such as illustrated in FIGS. 3A and 3B.

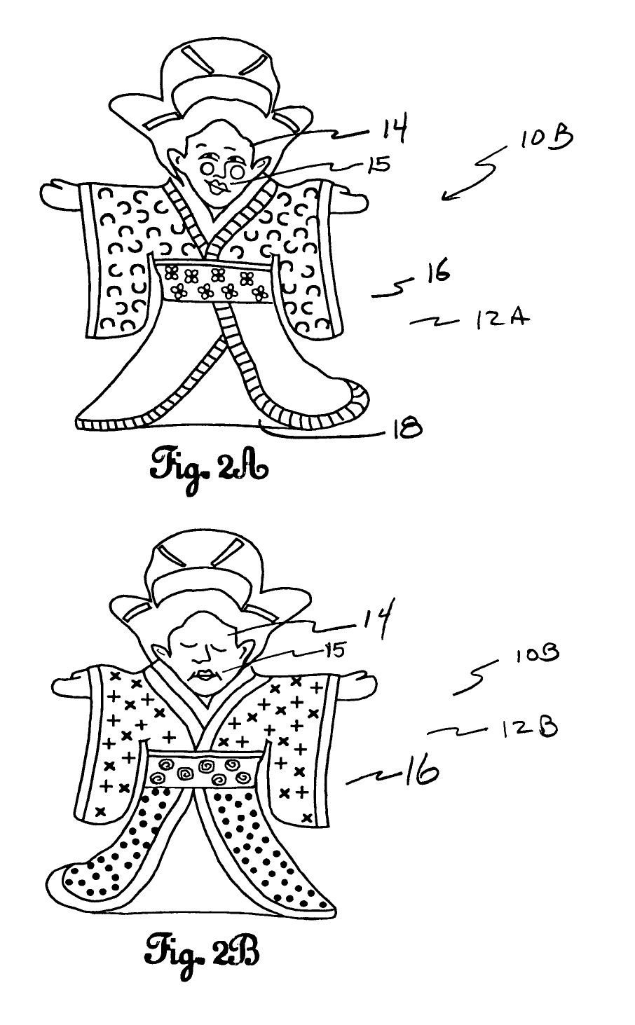

The figures may be multi-cultural as represented for example by the facial features and generally dress illustrated in FIGS. 2A and 2B, depicting an oriental character. The human characters may also be multi-racial or depict known fairy tale and folk tale characters.

The two sided puppets may be constructed from washable felt and may be used to act out stories while teachers, parents, or friends read a book or script. Children can be encouraged to use the puppets to interact with a teacher, parent, or friend.

The two sided puppets may also include a collection of silly animals with a happy side and a sad side. The idea of positive behavior or negative behavior may be reinforced through using the contrasting two sides (12A and 12B) of the puppets. Being able to flip the hand held puppet quickly from one side to the other encourages a child to develop a dialogue with a friend or a puppet or to help explain good and bad behavior. Moreover, the puppets, with one on each hand, can be used simultaneously reflecting contrasting emotions.

The two sided puppets may also be used to help young people deal with troubles and difficulties encountered in family, school or society in general, and may be used by a therapist to help develop dialogue with a child patient. One puppet may be used on one hand by the therapist or two puppets on two hands to assist in drawing out a child or explaining proper or improper behavior to a child.

A series of drama puppets may be provided with characters drawn from operas or plays. Typically, in operas or plays characters have a positive side and a negative side. The puppets may be configured with facial expressions but reflect these two different sides and may be used in conjunction with telling the story of the play. Indeed, the puppets may carry indicia thereon, such as the name of the character (see “Olga” FIGS. 1A and 1B) from the play such that there is an immediate positive and direct association between the name of the puppet and the character of the play.

A first example of using Applicant's novel two sided puppets, in conjunction with a story line involving a young clumsy bear (see puppet 10C). The bear was having a difficult time doing anything right (see FIG. 3A side 12A). One day someone teaches him how to do things right and he is happy (FIG. 3B side 12B of the bear displayed to the children). The sad side of the character is typically displayed when he couldn't do anything right and when he learned how, the happy side may be displayed.

Aesop's Fables are well known with story lines that conclude with a “moral” or lesson learned. Characters including those depicted in Aesop's Fables maybe provided with contrasting emotions depicted and used to tell the Fable and explain the lesson to be derived from the story line.

A lesson planned designed around Applicant's novel two sided puppets are set forth below.

Hibernation Lesson Plan

Lesson 1: Olga the Ballerina
Grade Level: Kindergarten
Approximate Time: 5 minutes
Objectives:
   Knowledge—students will identify letters “B” in the word Ballerina and “O” in the name “Olga”.
   Application—students will interact with the puppet during the lesson.
   Comprehension—students will explain what they learned about the Ballerina after the puppet presentation.
   Synthesis—students will illustrate their knowledge of dance and effort by drawing in their journals.
      Materials:
1. Puppets and Script
2. Student Journals
3. Lesson Plan
4. Pencils
5. Crayons
   Procedures:
1. Call the students to their story telling area.
2. Tell the students that they will learn about “Olga the Ballerina”. Ask them what letter “Olga” and “Ballerina” start with the alphabet, introduce the puppet.
   Olga the Ballerina's Script:
   “I am so clumsy when I dance . . . Boo”
   “My teacher says she will teach me . . . Rah!”
   “Today I was too scared to dance . . . Boo”
   “Then I danced anyway and did very well! . . . Rah!”

As be seen, Applicant's novel puppets (10A, 10B and 10C) maybe provided with a script personalized to the character and describing a sad/bad and happy/glad situation by utilizing the contrasting expressions on the face of the two sides of the puppets. Applicant further provides a kit with puppets and a script. As seen from the accompanying illustrations, puppets (10A, 10B and 10C) have a first side (12A), and a second side (12B). The two sides are substantially similar in appearance except in the expression of the face (14). The face (14) will typically include a mouth (15). While the face of the two sides is generally the same, typically mouth and other anatomical parts of the face will express contrasting expressions. That is, it is immediately clear that the same face is on both sides of the same character (10A, 10B or 10C) but the expression on the face thereof, including a mouth portion (15) is contrasting—for example a smile and a frown.

Other scripts illustrating contrasting emotions, the naming of the character and a word to reflect the facial expression and situation (“Boo/Rah” as set forth below) are:

BooRah Puppet Script:
Mel the Monkey's Script:
“EEEk, Eek, I have nothing to eat . . . Boo”
“My Mommy is going to give me a banana! . . . Rah!”
“OOOO! I have a banana but can't open it . . . Boo”
“My mommy showed me how, now I can eat it . . . Rah!”

Sue Shee's Script:
“I have no fish . . . Boo”
“Daddy is going fishing . . . Rah!”
“Daddy didn't catch a big fish . . . Boo”
“But he did catch a little fish just for me . . . Rah!”

Lab Pups' Script:
“Whimper, Whimper, I lost my ball . . . Boo”
“Woof, woof, I got a new one . . . Rah”

Sides 12A and 12B typically, then, include a face portion and a body portion (16) which may include clothing or highly stylized costumes (see FIG. 2A and 2B). Opening (18) is typically provided at the base or primitive portion (19) of the puppet for insertion for the hand therein. Indicia (20) may be provided and may personalize the puppet with a name (“Olga”) and/or an activity (the “Ballerina”) and/or indicia reflecting an emotion as in “Boo” and “Rah” as set forth in FIGS. 3A and 3B.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A teaching puppet adapted for fitting on the hand of a teacher, the puppet comprising:
a first side, the first side depicting a character having a face with a first expression reflecting a first emotion; and
a second side depicting the same character, generally opposite said first side, the second side having the face of the first side with a second expression reflecting a second emotion.

2. The teaching device of claim 1 wherein the face of the first side includes the mouth reflecting a frown, and the face of the second side includes the mouth reflecting a smile.

3. The teaching device of claim 1 wherein the character represents a non-human animal.

4. The teaching device of claim 1 wherein the character represents a human.

5. The teaching device of claim 1 wherein the first side further includes a first indicia on a surface thereof, and wherein the second side includes a second indicia on the surface thereof.

6. The teaching device of claim 4 wherein the first side includes indicia on the surface thereof, and the second side includes the same indicia on the surface thereof, which indicia reflects a personalized name for a character.

7. A teaching kit comprising:
a puppet adapted for fitting on the hand of a teacher, the puppet depicting a character having a first side, the first side having a face with a first expression reflecting a first emotion and a second side, generally opposite the first side, the second side having the face of the first side with a second expression reflecting a second emotion; and
a teaching script including a first portion of material designed to be used in conjunction with the first side of the puppet and a second portion of material designed to be used with the second side of the puppet.
